(19) United States
(12) Patent Application Publication
(10) Pub. No.: US 2015/0331875 A1
(43) Pub. Date: Nov. 19, 2015

(54) SYSTEM AND METHOD FOR VALIDATING INTEGRATED DATA RECASTING OBJECTS

(71) Applicant: SYNTEL, INC., Troy, MI (US)

(72) Inventors: Ravi P. Regidi, Pune (IN); Yatika Girdhar, Pune (IN)

(73) Assignee: SYNTEL, INC., Troy, MI (US)

(21) Appl. No.: 14/279,484

(22) Filed: May 16, 2014

(51) Int. Cl. G06F 17/30

(52) U.S. Cl. CPC G06F 17/30082

(57) ABSTRACT

A system for validating integrated data recasting objects includes a data storage having a rules library containing a plurality of object rules and one or more repositories each containing integrated data and one or more recasting objects, each of the one or more recasting objects containing a plurality of objects, an integrated data validation module on one or more computers to conduct a validity test of at least one of the plurality of objects of a selected one of the one or more recasting objects of a selected one of the one or more repositories for compliance with one or more of the plurality of object rules, and a report module on one or more computers to produce a graphical representation of at least one result of the validity test.

### FIELD OF THE INVENTION

The present invention relates generally to systems and methods for testing and validating objects used in data integration, and more specifically to systems and methods for validating objects used to recast data from heterogeneous data sources into a single repository of integrated data.

### BACKGROUND

Data integration is generally understood to refer to a process by which heterogeneous data is combined into a single, unified schema. A number of such processes are known, and some such processes utilize one or more objects to recast heterogeneous data into a single, queryable repository of integrated data. Such recasting objects are generally subject to one or more recasting rules in order to provide for uniformity and repeatability of integrated data across multiple repositories.

### SUMMARY

The present invention may comprise one or more of the features recited in the attached claims, and/or one or more of the following features and combinations thereof. In a first example aspect, a system for validating integrated data recasting objects may comprise a data storage including a rules library containing a plurality of object rules and one or more repositories each containing integrated data and one or more recasting objects, each of the one or more recasting objects containing a plurality of objects, one or more computers communicatively coupled to the data storage, an integrated data validation module on at least one of the one or more computers to conduct a validity test of at least one of the plurality of objects of a selected one of the one or more recasting objects of a selected one of the one or more repositories for compliance with one or more of the plurality of object rules, and a report module on at least one of the one or more computers to produce a graphical representation of at least one result of the validity test.

In a second example aspect, the integrated data validation module in the system of first example aspect may conduct the validity test of each of a selected subset of the plurality of objects.

In a third example aspect, the plurality of object rules in the system of either of the first and second example aspects may include a first subset of object rules and a second subset of rules that has at least one of the plurality of object rules that is not included in the first subset of rules, and the integrated data validation module may conduct the validity test of a first one of the selected subset of the plurality of objects for compliance with the first subset of object rules and of a second one of the selected subset of the plurality of objects for compliance with the second subset of rules.

In a fourth example aspect, the integrated data validation module of any of the first—third example aspects may be responsive to user selection of one of the one or more repositories, to user selection of one of the one or more recasting objects of the selected repository, and to user selection of one or more of the plurality of objects of the selected recasting object to conduct the validation test.

In a fifth example aspect, the system of any of the first—fourth example aspects may further comprise a display monitor communicatively coupled to at least one of the one or more computers, and the report module may control the display monitor to produce the graphical representation of the at least one result of the validity test in the form of a graphical representation of a pass or fail of compliance of the at least one of the plurality of objects with the one or more of the plurality of object rules.

In a sixth example aspect, the report module of the fifth example aspect may control the display monitor to produce the graphical representation of the pass or fail in the form of at least one of a table, a pie chart and a bar chart.

In a seventh example aspect, the report module of the sixth example aspect may control the display monitor to produce the graphical representation of the pass or fail in the form of a bar chart identifying pass or fail with respect to one or more of object naming convention, object documentation and object performance object rule categories.

In an eighth example aspect, the one or more repositories of any of the first—seventh example aspects may contain integrated data recast from heterogeneous data using an extract, transform and load process, and the one or more recasting objects of the at least one of the one or more repositories may include at least a mapping object, a session object and a workflow object.

In a ninth example aspect, a system for validating integrated data recasting objects may comprise a data storage including a rules library containing a plurality of object rules and one or more repositories each containing integrated data and one or more recasting objects, each of the one or more recasting objects containing a plurality of objects, at least one processor communicatively coupled to the data storage, and a memory having instructions stored therein which, when executed by the at least one processor, cause the at least one processor to access a user selected one of the one or more repositories, access a user selected one of the recasting objects of the user selected one of the one or more repositories, access a user selected one or subset of the plurality of objects of the user selected one of the one or more recasting objects, conduct a validity test of the user selected one or each of the subset of the plurality of objects for compliance with one or more of the plurality of object rules.

In a tenth example aspect, the plurality of object rules of the ninth example aspect may include a first subset of object rules and a second subset of rules that has at least one of the plurality of object rules that is not included in the first subset of rules, and the instructions stored in the memory may further include instructions which, when executed by the at least one processor, cause the at least one processor to conduct the validity test of a first one of the selected subset of the plurality of objects for compliance with the first subset of object rules and of a second one of the selected subset of the plurality of objects for compliance with the second subset of rules.

In an eleventh example aspect, the user selected one of the one or more repositories of either of the ninth and tenth example aspects may contain integrated data recast from heterogeneous data using an extract, transform and load process, and the one or more recasting objects of the user selected one of the one or more repositories may include at least a mapping object, a session object and a workflow object.

In a twelfth example aspect, the system of any of the ninth—eleventh example aspects may further comprise a display monitor communicatively coupled to the at least one processor, and the instructions stored in the memory may further include instructions which, when executed by the at least one processor, cause the at least one processor to control the display monitor to display a graphical representation of at least one result of the validity test.

In a thirteenth example aspect, the instructions stored in the memory of the twelfth example aspect may further include instructions which, when executed by the at least one processor, cause the at least one processor to control the display monitor to display the graphical representation of the at least one result of the validity test in the form of a graphical representation of a pass or fail of compliance of the at least one of the plurality of objects with the one or more of the plurality of object rules.

In a fourteenth example aspect, the instructions stored in the memory of the thirteenth example aspect may further include instructions which, when executed by the at least one processor, cause the at least one processor to control the display monitor to display the graphical representation of the pass or fail in the form of at least one of a table, a pie chart and a bar chart.

In a fifteenth example aspect, the instructions stored in the memory of the fourteenth example aspect may further include instructions which, when executed by the at least one processor, cause the at least one processor to control the display monitor to display the graphical representation of the pass or fail in the form of a bar chart identifying pass or fail with respect to one or more of object naming convention, object documentation and object performance object rule categories.

In a sixteenth example aspect, a method for validating integrated data recasting objects may comprise receiving on a computing device a first user input identifying a selected one of one or more repositories of integrated data stored in a data storage, each of the one or more repositories including, in addition to the integrated data, one or more recasting objects, each of the one or more recasting objects containing a plurality of objects, receiving on the computing device a second user input identifying a selected one of the one or more recasting objects of the selected one of the one or more repositories, receiving on the computing device a third user input identifying a selected one or subset of the plurality of objects of the selected one of the one or more recasting objects, and in response to a fourth user input received on the computing device, conducting a validity test of the selected one or each of the subset of the plurality of objects for compliance with one or more of a plurality of object rules stored in the data storage.

In a seventeenth example aspect, the selected one of the one or more repositories of the sixteenth example aspect may contain integrated data recast from heterogeneous data using an extract, transform and load process, and the one or more recasting objects of the selected one of the one or more repositories may include at least a mapping object, a session object and a workflow object, and receiving the second user input may comprise receiving a selection of one of the mapping object, the session object and the workflow object.

In an eighteenth example aspect, either of the sixteenth and seventeenth aspects may further comprise displaying a graphical representation of at least one result of the validity test on a display monitor.

In a nineteenth example aspect, any of the sixteenth—eighteenth example aspects may further comprise displaying the graphical representation of the at least one result of the validity test on the display monitor in the form of a graphical representation of a pass or fail of compliance of the at least one of the plurality of objects with the one or more of the plurality of object rules.

In a twentieth example aspect, the nineteenth example aspect may further comprise displaying the graphical representation of the pass or fail in the form of at least one of a table, a pie chart and a bar chart, the bar chart identifying the pass or fail with respect to one or more rule object rule categories.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for validating integrated data recasting objects.

FIG. 2 is a simplified block diagram of an embodiment of the data storage illustrated in FIG. 1.

FIG. 3 is a simplified flowchart of a process for validating integrated data recasting objects.

FIG. 4 is an example graphical user interface produced by the ID Validation Module of FIG. 1.

FIG. 5 is another example graphical user interface produced by the ID Validation Module of FIG. 1 and via which at least a portion of the process of FIG. 3 may be carried out.

FIG. 6 is yet another example graphical user interface produced by the ID Validation Module of FIG. 1 and via which at least a portion of the process of FIG. 3 may be carried out.

FIG. 7 is still another example graphical user interface produced by the ID Validation Module of FIG. 1 and via which at least a portion of the process of FIG. 3 may be carried out.

FIG. 8 is a further example graphical user interface produced by the ID Validation Module of FIG. 1 and via which at least a portion of the process of FIG. 3 may be carried out.

FIG. 9 is another example graphical user interface produced by the ID Validation Module of FIG. 1 and via which configuration of one or more repositories may be carried out.

FIG. 10 is yet another example graphical user interface produced by the ID Validation Module of FIG. 1 and via which configuration of one or more repositories may be carried out.

FIG. 11 is still another example graphical user interface produced by the ID Validation Module of FIG. 1 and via which configuration of one or more users may be carried out.

FIG. 12 is a further example graphical user interface produced by the ID Validation Module of FIG. 1 and via which configuration of one or more users may be carried out.

FIG. 13 is yet a further example graphical user interface produced by the ID Validation Module of FIG. 1 and via which configuration of one or more object rules may be carried out.

FIG. 14 is still a further example graphical user interface produced by the ID Validation Module of FIG. 1 and via which configuration of one or more object rules may be carried out.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

For purposes of this document, the following terms are defined: (1) “heterogeneous data” is data from any number of sources that is of differing or unknown format and/or content, (2) “integrated data” is data from one or more sources of heterogeneous data combined into a single, queryable repository, (3) “object” is or includes one or more of a variable, function, definition, and/or data structure, such as all or part of a table, map, instruction, set of instructions or other association between data and a database entity, (4) “recasting” is or includes one or more processes for transforming heterogeneous data into integrated data, and (5) “recasting object” is an object for transforming, or for conducting or facilitating at least a portion of a transformation of, heterogeneous data into integrated data.

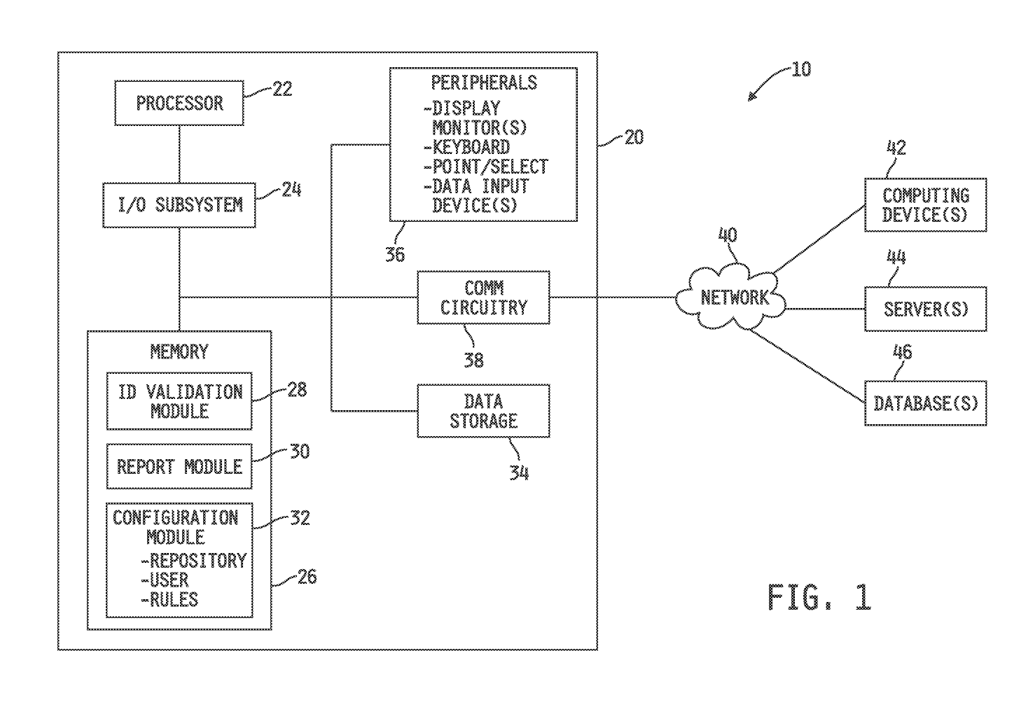

Referring now to FIG. 1, a system 10 is shown for validating integrated data recasting objects. In the illustrated embodiment, the system 10 includes a computing device 20 which may be coupled via a network 40 to one or more remote computing devices 42, one or more remote servers, and/or one or more remote databases 46. As will be described in detail below, the system 10 provides an for an automated validation process by which one or more objects of one or more recasting objects associated with an integrated data repository can be tested for compliance with one or more object rules contained within an object rules library. In one embodiment, repositories of integrated data may be stored in, and accessed from, a data storage device 34 contained within the computing device 20, although one or more of the repositories may alternatively be stored remotely, in whole or in part, in one or more of the one or more computing devices 42, the one or more servers 44 and the one or more databases 46 and accessed via the network 40. The automated validation process may illustratively be stored, e.g., in the form of instructions executable by one or more processors, in a memory device contained within the computing device 20, although the automated validation process may alternatively be stored remotely, in whole or in part, in one or more of the one or more computing devices 42, the one or more servers 44 and the one or more databases 46 and accessed via the network 40. In any case, the automated validation process may illustratively be executed by a processor contained within the computing device 20, although the automated validation process may alternatively be executed remotely, in whole or in part, by one or more remote processors contained within the one or more computing devices 42 and/or within the one or more servers 44, wherein information may be exchanged between the computing device 20, the one or more computing devices 42 and/or the one or more servers 44 via the network 40.

The computing device 20 may be embodied as any type of computing device (e.g., without limitation, a personal computer (PC), laptop computer, notebook computer, or the like) or other computing device capable of performing the functions described herein. In the illustrative embodiment of FIG. 1, the computing device 20 includes a processor 22, an I/O subsystem 24, a memory device (or devices) 26, a data storage device (or devices) 34, one or more peripheral devices 36 and communication circuitry 38. It should be appreciated that the computing device 20 may include other components, sub-components, and/or devices commonly found in computing devices, which are not illustrated in FIG. 1 for clarity of the description.

The processor 22 of the computing device 20 may be embodied as any type of processor capable of executing software/firmware, such as a microprocessor, digital signal processor, microcontroller, or the like. The processor 22 may be a single processor or include multiple processors. The I/O subsystem 24 of the computing device 20 may be embodied as circuitry and/or components to facilitate input/output operations with the processor 24 and/or other components of the computing device 20. The processor 22 is communicatively coupled to the I/O subsystem 24.

The memory 26 of the computing device 20 may be embodied as or otherwise include one or more conventional volatile and/or non-volatile memory devices. The memory 26 is communicatively coupled to the I/O subsystem 24 via a number of signal paths. Although only a single memory device 26 is illustrated in FIG. 1, the computing device 20 may, in other embodiments, include additional memory devices and/or be coupled directly to one or more remote memory devices.

Various data and/or software, e.g., in the form of instructions executable by the processor 22, may be stored in the memory 26. In the illustrated embodiment, for example, the memory 26 may have stored therein an integrated data (ID) validation module 28, a report module 30 and a configuration module 32. The ID validation module 28 illustratively contains instructions executable by the processor 22 (and/or one or more other processors) to conduct validation testing of one or more objects of one or more recasting objects associated with an integrated data repository for compliance with one or more object rules contained within an object rules library as briefly described above. The report module 30 illustratively contains instructions executable by the processor 22 (and/or one or more other processors) to produce one or more graphical representations of at least one result of the validity testing carried out under the direction of the ID validation module 28. The configuration module 32 illustratively contains instructions executable by the processor 22 (and/or one or more other processors) to configure, e.g., edit, add, delete and/or restrict access to, one or more integrated data repositories, to configure, e.g., edit, add, delete and/or restrict access to the system 10 by, one or more users, and to configure, e.g., edit, add, delete and/or activate/deactivate one or more object rules contained in an object rules library. As briefly described above, any one or more of the ID validation module 28, the report module 30 and the configuration module 32 may be alternatively stored remotely, in whole or in part, in one or more computing devices 42, one or more servers 44 and/or in one or more databases 46.

In the illustrated embodiment, the computing device 20 further includes a number of peripheral devices 36. Such peripheral devices 36 may include any number of additional input/output devices, interface devices, and/or other peripheral devices. For example, as illustrated in FIG. 1 the peripheral devices 36 may include, without limitation, one or more display monitors, at least one keyboard, at least one point and select device, e.g., a mouse, and one or more data input devices, e.g., a memory disk reading device, one or more input ports for connecting to one or more corresponding memory devices, e.g., one or more universal serial bus (USB) input ports, or the like. It will be understood that the peripheral devices 36 may alternatively or additionally include one or more other conventional input and/or output devices. In any case, the peripheral devices 36 are communicatively coupled to the I/O subsystem 24 via a number of signal paths.

The communication circuitry 38 of the computing device 20 may include any number of devices and/or circuitry for enabling communications between the computing device 20 and any of one or more remote computing devices 42, one or more remote servers 44 and/or one or more remote databases 46. In the illustrated embodiment, for example, communication between the computing device 20 and any of the one or more remote computing devices 42, the one or more remote servers 44 and/or the one or more remote databases 46 takes place wirelessly via the network 40, wherein the network 40 may represent, for example, a private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the computing device 20 and any of the one or more remote computing devices 42, one or more remote servers 44 and/or one or more remote databases 46 may be a non-private network and/or may be, in whole or in part, a wired connection. Generally, the communication circuitry 38 may be configured to use any one or more, or combination, of conventional secure and/or unsecure communication protocols to communicate with any of the one or more remote computing devices 42, one or more remote servers 44 and/or one or more remote databases 46. As such, the network 40 may include any number of additional devices, such as additional computers, routers, and switches, to facilitate communications between the computing device 20 and any of the one or more remote computing devices 42, one or more remote servers 44 and/or one or more remote databases 46. In any case, the communication circuitry 38 is communicatively coupled to the I/O subsystem 24 via a number of signal paths.

The one or more remote computing devices 42 and/or the one or more remote servers 44 may be substantially similar to the computing device 20 as just described, and may include similar components. As such, the description provided above of the components of the computing device 20 may be equally applicable to such similar components of the one or more remote computing devices 42 and/or the one or more remote servers 44, and are not repeated herein so as not to obscure the present disclosure. Of course, it should be appreciated that in some embodiments any of the one or more remote computing devices 42 and/or the one or more remote servers 44 and may be dissimilar to others of the one or more remote computing devices 42 and/or remote servers 44.

The data storage 34 is also communicatively coupled to the I/O subsystem 24 via a number of signal paths, and may be embodied as any type of device or devices configured for the short-term or long-term storage of data such as, for example, one or more memory devices and circuits, memory cards, hard disk drives, solid-state drives, or other data storage devices. Although only a single data storage device 34 is illustrated in FIG. 1, the computing device 20 may, in other embodiments, include additional data storage devices and/or be coupled directly to one or more remote data storage devices.

Among other data and/or software that may be stored in the data storage 34, the data storage 34 illustratively includes one or more databases stored therein. At least one of such one or more databases illustratively has one or more repositories of integrated data stored therein. Each such one or more repository of integrated data illustratively includes, in addition to the integrated data, one or more recasting objects stored therein which operate(s) to transform, or to conduct or facilitate at least a portion of a transformation of, heterogeneous data into the integrated data. Any one or combination of known techniques and/or processes may be used to combine and transform heterogeneous data into integrated data, and any such one or combination of known techniques and/or processes may include any number of associated recasting objects. While it will be understood that the concepts of this disclosure may be implemented to conduct validation testing of integrated data formed using any such known technique(s) and/or process(es), the remainder of this disclosure will be described in the context of one example set of integrated data formed using a conventional Extract, Transform, Load (ETL) process. In this regard, ETL data typically has associated therewith at least three recasting objects generally known as a mapping, a session and a framework. In the general sense, a mapping is or includes a set of instructions having source and target definitions linked by transformation objects that define the mapping of heterogeneous source data to a target integrated data repository, a session is or includes a set of instructions that define how and when to move data from sources to targets, and a workflow is or includes a set of instructions that controls execution of mappings and defines how and when to execute sessions and any other tasks to be performed. In the context of ETL, a repository of ETL integrated data will thus typically contain at least the integrated data, a mapping object, a session object and a session object, wherein each of the mapping, session and workflow objects include a plurality of objects (as the term “object” is defined herein).

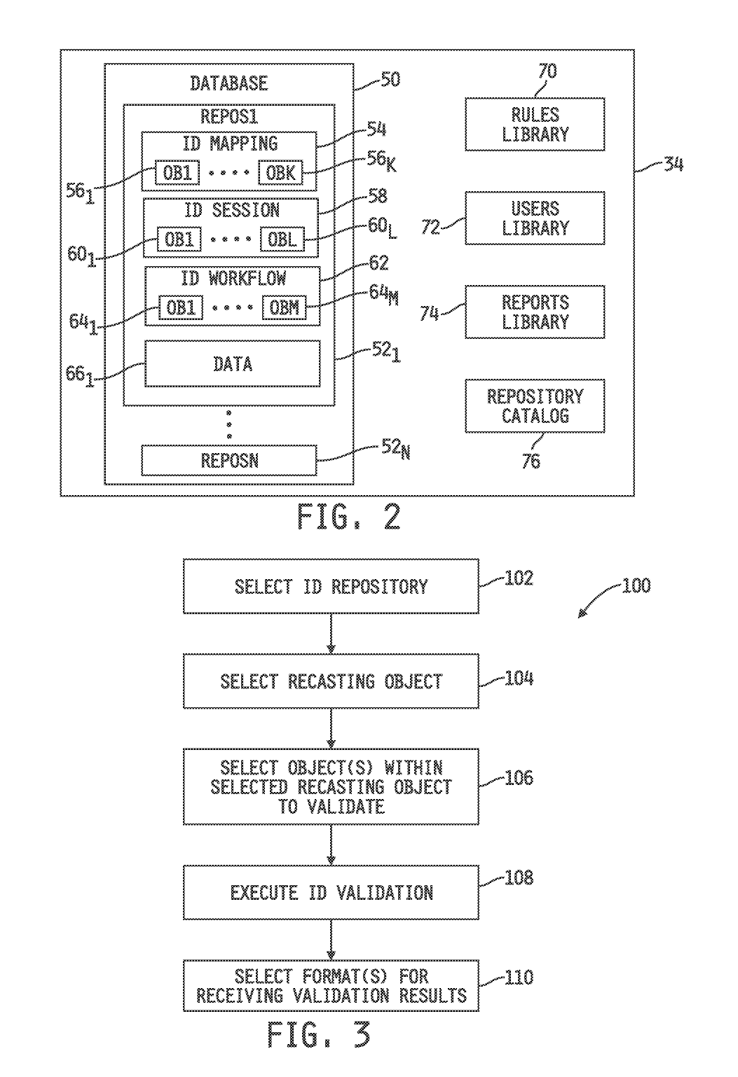

Referring now to FIG. 2, a simplified block diagram is shown of an embodiment of the data storage device 34 of FIG. 1. In the illustrated embodiment, the data storage device 34 has stored therein at least one database 50 containing a number, N, of repositories 52₁-52_{N}, where N may be any positive integer. The repository 52, is illustratively an integrated data repository formed using a conventional ETL process, and the repository 52₁ therefore has stored therein an integrated data (ID) mapping object 54, an integrated data (ID) session object 58, an integrated data (ID) workflow object 62 and at least one set of integrated data 66₁. In some alternative embodiments, one or more of the mapping object 54, the session object 58 and the workflow object 62 may be stored separately from the integrated data repository 52₁. In any case, as described above, the mapping object 54 illustratively includes one or more objects 56₁-56_{K} (i.e., OB1-OBK), where K may be any positive integer, the session object 58 illustratively includes one or more objects 60₁-60_{L} (i.e., OB1-OBL), where L may be any positive integer and the workflow object 62 illustratively includes one or more objects 64₁-64_{M} (i.e., OB1-OBM), where M may be any positive integer. One or more of the remaining repositories 52₂-52_{N} may likewise be an integrated data repository formed using a conventional ETL process and/or using one or more other integrated data formation processes. In any such repositories 52₁-52_{N}, the data and/or objects may alternatively be stored remotely, in whole or in part, e.g., in one or a combination of the one or more computing devices 42, the one or more servers 44 and the one or more databases 46.

In the embodiment illustrated in FIG. 2, the data storage 34 also has stored therein a rules library 70, a users library 72, a reports library 74 and a repository catalog 76. The rules library 70 illustratively has stored therein a plurality of object rules which define standards for the various types of objects contained within the mapping object 54, the session object 58 and the workflow object 62. Illustratively, the object rules may be grouped according to rule type in a corresponding one of a number of different rule categories. Examples of such rule categories may include, but should not be limited to, naming conventions, documentation standards, performance standards, and the like. In the following Table I, which should not be considered to be limiting in any way, one illustrative example is shown of a table-formatted rules library 70.

TABLE I

| | DATA | |
|---|---|---|
| COLUMN NAME | TYPE | DESCRIPTION |
| RULE_DESC | Text | Description of the rule |
| OBJECT_TYPE | Text | The object type being validated |
| RULE_SYNTAX | Memo | The SQL Query that validates |
| RULE_CATEGORY | Text | Type of rule applied (Naming Convention, |
| | | Performance and Documentation) |
| RULE_IS_ACTIVE | Text | To check whether Rule is Active or Inactive |

The users library 72 illustratively has stored therein information about authorized users of the system 10. In the following Table II, which should not be considered to be limiting in any way, one illustrative example is shown of a table-formatted users library 72.

TABLE II

| | DATA | |
|---|---|---|
| COLUMN NAME | TYPE | DESCRIPTION |
| USER_ID | Text | Username |
| PASSWORD | Text | Password |
| ROLE | Text | User or Admin |
| USR_IS_ACTIVE | Text | User active or inactive |

The reports library 74 illustratively has stored therein the results of previously conducted validation tests. In the following Table III, which should not be considered to be limiting in any way, one illustrative example is shown of a table-formatted reports library 74.

TABLE III

| | DATA | |
|---|---|---|
| COLUMN NAME | TYPE | DESCRIPTION |
| REP_NAME | Text | Name of the repository |
| OBJECT_ID | Number | The unique identifier of the object |
| OBJECT_NAME | Text | Name of the object |
| PARENT_OBJ_NAME | Text | Name of the parent object |
| FOLDER_NAME | Text | Name of the folder |
| RULE_STATUS | Text | Status (PASS or FAIL) |
| RULE_RESPONSE | Memo | Description of the rule |
| VAL_TMST | Date/Time | Time of the validation |
| CYCLE_NBR | Number | Incremented every cycle |

The repository catalog 76 illustratively has stored therein the configuration information for each repository stored in the database 50. In the following Table IV, which should not be considered to be limiting in any way, one illustrative example is shown of a table-formatted repository catalog 76.

TABLE IV

| COLUMN | DATA | |
|---|---|---|
| NAME | TYPE | DESCRIPTION |
| REP_NAME | Text | Name of the Repository |
| REP_USER | Text | Username of the Repository |
| PASSWORD | Text | Password |
| REP_CONN | Memo | Connection String to configure repository |
| REP_IS_ACTIVE | Text | To check whether Repository is Active or |
| | | Inactive |

As described briefly hereinabove, one or more of the rules library 70, the users library 72, the reports library 74 and the repository catalog 76 may alternatively be remotely stored, in whole or in part, e.g., in one or a combination of the one or more computing devices 42, the one or more servers 44 and the one or more databases 46.

Referring now to FIG. 3, a simplified flowchart is shown of a process 100 for validating integrated data recasting objects. The process 100 is illustratively stored in the memory 26, e.g., as part of the ID validation module 28 and the report module 30, in the form of instructions which, when executed by a processor, e.g., the processor 22 and/or one or more remotely located processors, cause the processor(s) to execute the various functions of the process 100. In alternate embodiments, the process 100 may be remotely stored, in whole or in part, e.g., in one or a combination of the one or more computing devices 42, the one or more servers 44 and the one or more databases 46.

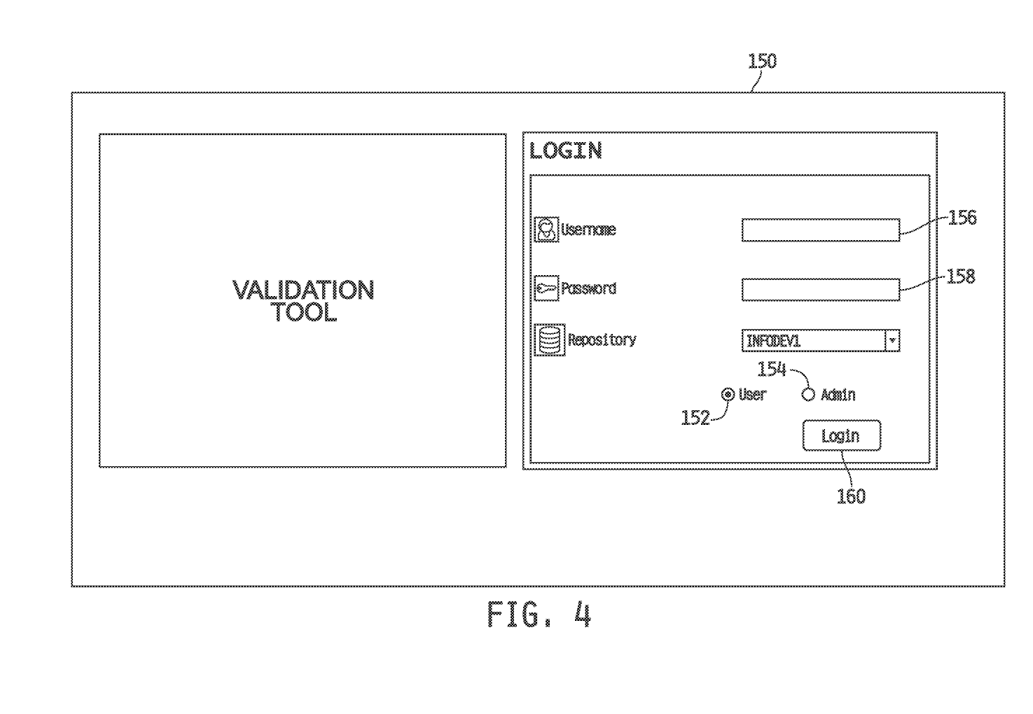

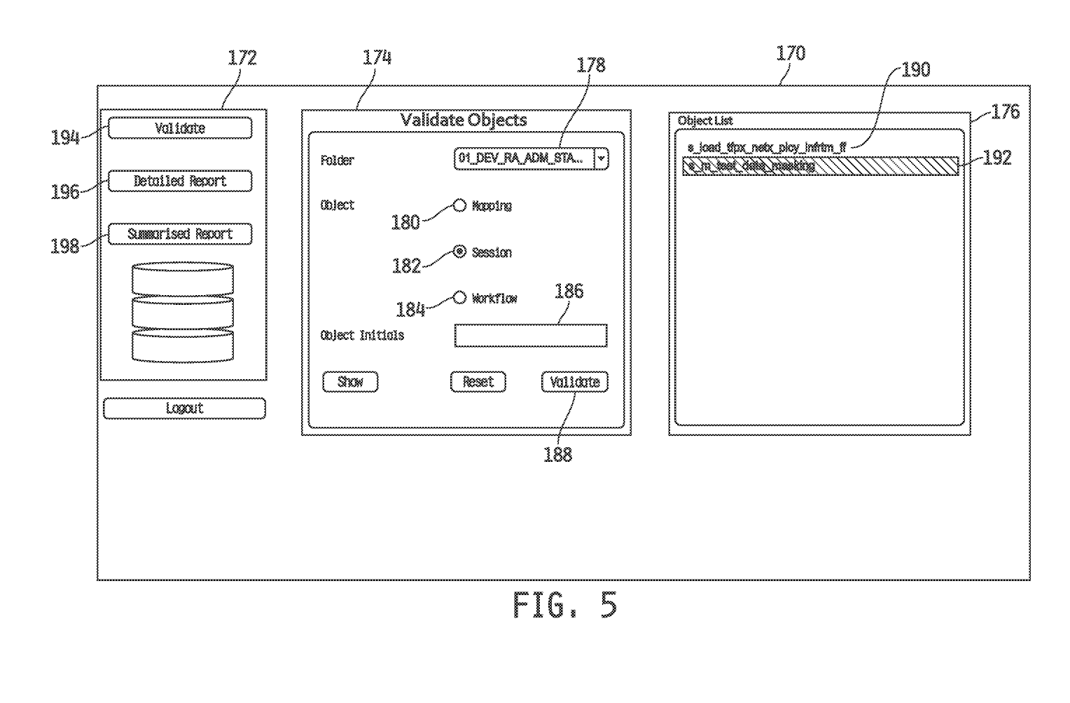

Prior to execution of the first step 102 of the process 100, a user first logs into the system 10, e.g., using a graphical interface 150 of the type illustrated in FIG. 4 displayed by the processor 22 on a display monitor included in the peripheral devices 36 of the computing device 20. The user may log into the system 10 as a user or an administrator via appropriate selection of a corresponding User graphic 152 and an Admin graphic 154. Illustratively, users of the system 10 may execute validation tests, as will be described in detail below, but typically only administrators will be authorized to alter any of the rules library 70, the users library 72 and the repository catalog 76. In any case, the user enters a username at an input location 156, a password at another input location 158 and then selects the Login graphic 160 to log into the system 10.

Referring again to FIG. 3, the process 100 begins at step 102 where the user (or administrator) selects one of the integrated data repositories, e.g., one of the repositories 52₁-52_{N}, stored in the database 50 (and/or stored in a remote database). Thereafter at step 104, the user selects one of the recasting objects associated with, and illustratively stored within, the selected integrated data repository. Thereafter at step 106, the user selects one or more objects contained within the selected recasting object. Thereafter at step 108, the user selects execution of the integrated data validation process which conducts validation testing of each of the selected objects for compliance with the object rules contained within the object rules library 70.

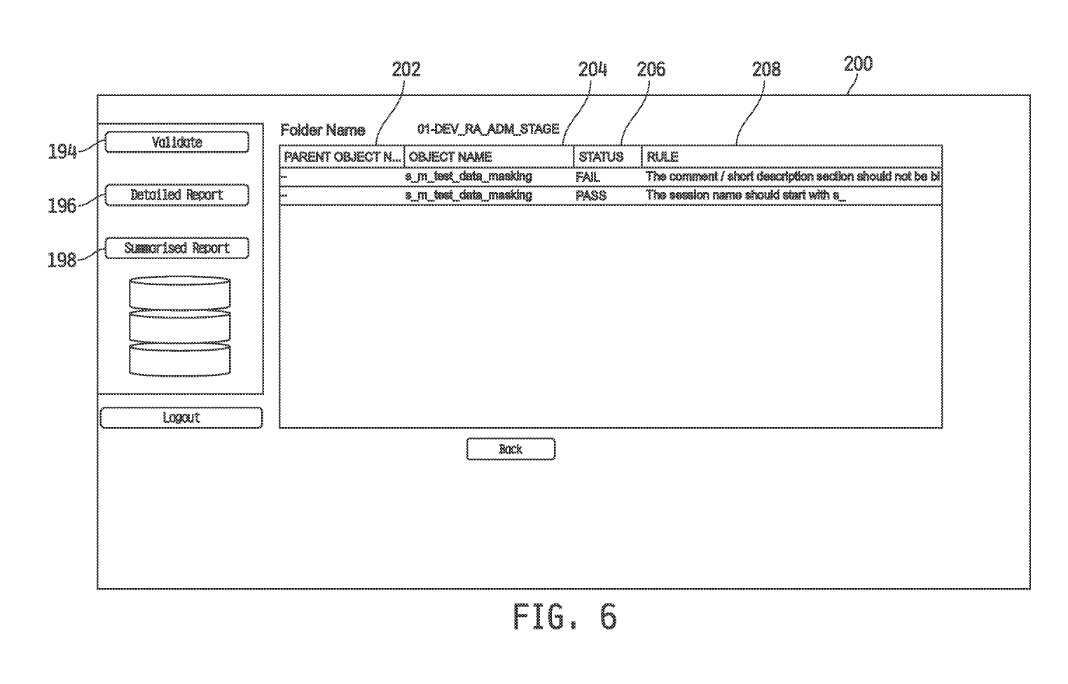

Referring now to FIG. 5, an example graphical interface 170 is shown, which is displayed by the processor 22 on a display monitor included in the peripheral devices 36 of the computing device 20, via which a user or administrator of the system 10 may execute steps 102-108 of the process 100 illustrated in FIG. 3. In the illustrated embodiment, the graphical interface 170 includes a legend section 172 illustratively containing a selectable Validate graphic 194, a selectable Detailed Report graphic 196 and a selectable Summarised Report graphic 198. Each of the graphics 194, 196 and 198 may be selected by a user or administrator to cause the processor 22 to control the display monitor to display a corresponding graphical interface. Selection of the Validate graphic 194, for example, produces the graphical interface 170, and selection of the graphics 196 or 198 causes the processor 22 to produce corresponding validation report graphical user interfaces, examples of which are illustrated in FIGS. 6-8.

The graphical interface 170 also includes a Validate Objects section 174 via which the user or administrator can execute steps 102, 104 and 108 of the process 100 illustrated in FIG. 3. For example, the graphical the interface section 174 includes a pull-down folder menu 178 via which the user or administrator may select an integrated data repository from the database 50 for validation of one or more of its associated recasting objects. The graphical interface section 174 further includes a recasting object graphic menu via which the user or administrator may select one or any combination of the mapping object 180, the session object 182 and the workflow object 184. Illustratively, the graphical interface section 174 further includes an object initials input section 186 via which the user or administrator may enter object initials to search the database 50 for a particular mapping, session or workflow starting with, or including, the entered initials. The section 174 further includes a Validate graphic which causes the processor 22 to conduct a validity test of the selected objects.

The graphical interface 170 further includes an Object List section 176 via which the user or administrator may select one or more of the objects contained in the selected recasting object(s). Illustratively, the instructions stored in the memory 26 cause the processor 22 to automatically populate the Object List with all objects contained within the selected recasting object(s) upon selection thereof. Further illustratively, the user or administrator may select for validation testing any one or combination of the objects listed in the Objects List by directly selecting any such one or combination of objects.

In the example illustrated in FIG. 5, the user or administrator has executed step 102 of the process 100 illustrated in FIG. 3 by selecting via the pull-down menu 178 the integrated data repository 01_DEV_RA_ADM_STA . . . . The user has further executed step 104 of the process 100 by selecting the session object 182. In response to user selection of step 104, the processor 22 automatically retrieves each of the objects contained in the selected session object and displays the retrieved objects in the Object List Section 176. In the example illustrated in FIG. 5, the session object of the integrated data repository 01_DEV_RA_ADM_STA . . . includes 2 objects 190 and 102; i.e., objects s_load_tfpx_netx_plcy_infrtm_ff and s_m_test_data_masking. The user has further executed step 106 by selecting the object 192, which illustratively highlights this object as shown in FIG. 5 to indicate user selection of the object. In one embodiment, selection of the recasting objects 180, 182 and 184 and of the objects listed in the Object List Section 176 is an AND function such that any one or combination of the recasting objects 180, 182, 184 may be selected for validation testing of one or more of its/their objects, and any one or combination of the objects in the Object List Section 176 may be selected for validation testing. In alternative embodiments, selection of the recasting objects 180, 182 and 184 and/or selection of objects in the Object List Section 176 may be an OR function. In any case, in the example illustrated in FIG. 5, the user or administrator has elected to conduct validation testing of the s_m_test_data_masking object of the session object contained in the integrated data repository 01_DEV_RA_ADM_STA . . . . Following execution of step 106 in the process 100, the user or administrator may select the Validate graphic 188 in the Validate Objects Section 174 to conduct validation testing of the selected object(s).

Validation testing of the selected one or subset of the objects listed in the Object List Section 176 is carried out by the processor 22 by comparing each such object to one or more applicable rules contained in the object rules library 70. Any object may be compared with any number of object rules in any of the one or more object rule categories, e.g., naming convention, documentation and/or performance, by comparing the language of the object with a rule syntax associated with each object rule. Typically, different objects will be compared with different object rules or sets of object rules such that a set of object rules used to conduct validation testing of one object in the Object List Section 176 may differ by at least one object rule from a set of rules used to conduct validation testing of another object in the Object List Section. In any case, an object in the Object List Section is considered to pass validation testing if it is determined by the processor 22 to comply with each applicable object rule in the library of object rules 70, and is otherwise considered to fail validation testing.

Referring again to FIG. 3, the process 100 proceeds from step 108 to step 110 where, following completion of the validation testing, the user or administrator may select one or more report formats for viewing the results of the validation testing. Referring to FIG. 6, an example graphical interface 200 is shown of one such report format which is displayed by the processor 22 on a display monitor included in the peripheral devices 36 of the computing device 20. In the illustrated embodiment, the results of the example object s_m_test_data_masking selected for validation testing in FIG. 5 are shown. The example report illustrated in FIG. 6 is illustratively provided in the form of a table for the integrated data repository 01-DEV_RA_ADM_STAGE. The results table illustrated in FIG. 6 illustratively includes a Parent Object Name column 202, which may identify parent objects selected for validation testing, e.g., mapping, session or workflow, an Object Name column 204, which may identify objects selected from the Object List Section 176 for validation testing, a Status column 206, which may identify results, e.g., pass or fail, of the validation test conducted for each object, and a Rule column 208, which may identify each object rule against which each object was tested. In the validation test report illustrated in FIG. 6, for example, the object s_m_test_data_masking failed an object rule relating to a comment/short description section of the object, but passed an object rule relating to the name of the selected session.

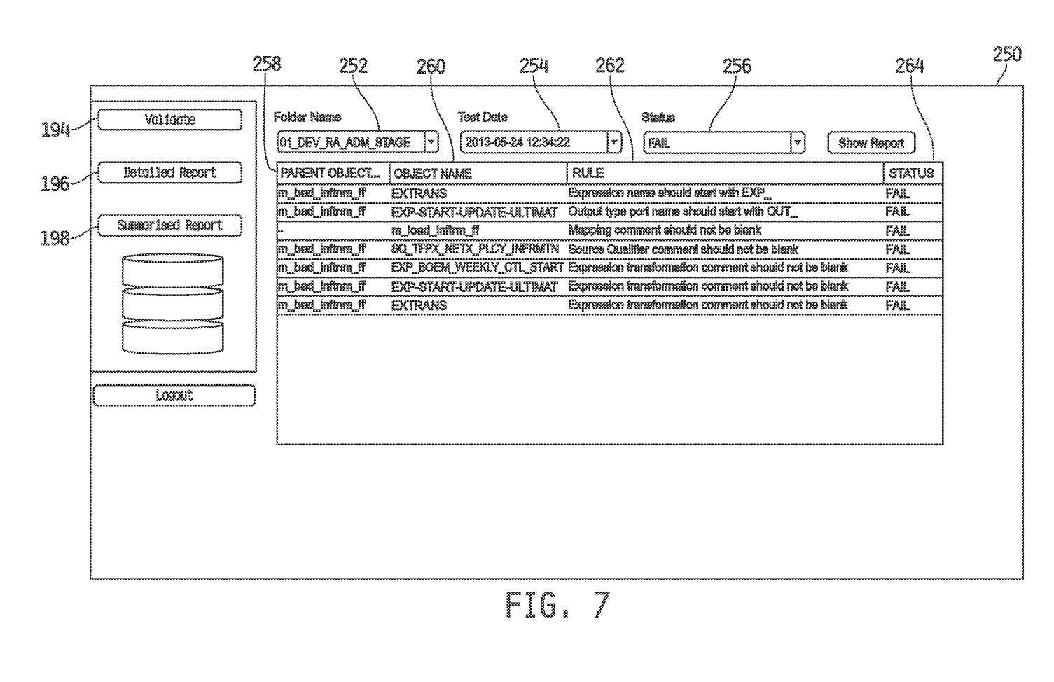

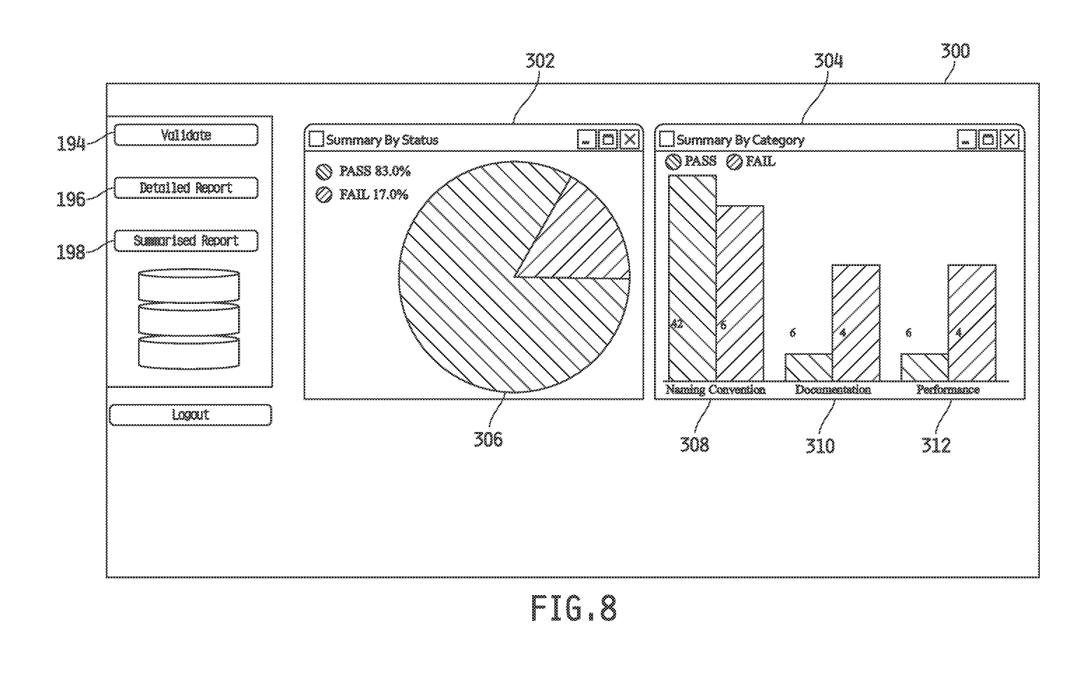

The user or administrator may alternatively or additionally wish to review a more detailed report of the validation testing results, and in this regard FIG. 7 shows an example graphical interface 250 of one such detailed report format which is displayed by the processor 22 on a display monitor included in the peripheral devices 36 of the computing device 20. The detailed report graphical interface 250 illustratively includes a Folder Name pull-down menu 252 via which a detailed report of any selectable integrated data repository may be viewed, a test date pull-down menu 254v via which a detailed report of a validation test of a selected integrated data repository generated on any of various selectable test dates may be viewed, and a status pull-down menu 256 via which a detailed report of pass or fail results only may be viewed. For any such selected validation report to view, the detailed report includes a Parent Object Name column 258, which may identify parent objects selected for validation testing, e.g., mapping, session or workflow, an Object Name column 260, which may identify objects selected from the Object List Section 176 for validation testing, a Rule column 262, which may identify each object rule against which each object was tested, and a Status column 264, which may identify results, e.g., pass or fail, of the validation test conducted for each object.

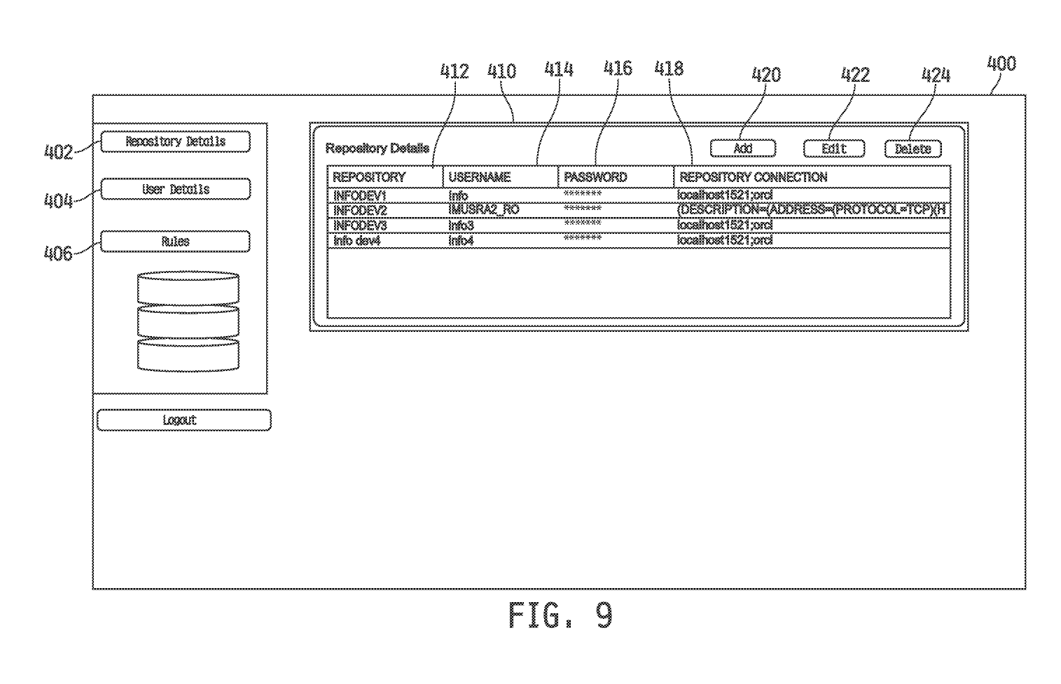

The user or administrator may alternatively or additionally wish to review a Summarised report of the validation testing results, and in this regard FIG. 8 shows an example graphical interface 300 of one such detailed report format which is displayed by the processor 22 on a display monitor included in the peripheral devices 36 of the computing device 20. The Summarised report graphical interface 300 illustratively includes a Status Summary interface 302 which displays, e.g., by percentage, a pass/fail comparison result, e.g., in the form of a pie chart. In the example illustrated in FIG. 8, 83 percent of the objects tested passed the validation test being reported while 17 percent failed. Alternatively or additionally, the Summarised report graphical interface 300 may include a Category Summary interface 304 which displays pass/fail results, e.g., percentage or number of tests, of a validation test partitioned into each of the various object rule categories, e.g., by naming convention, documentation and performance object rule categories or types.

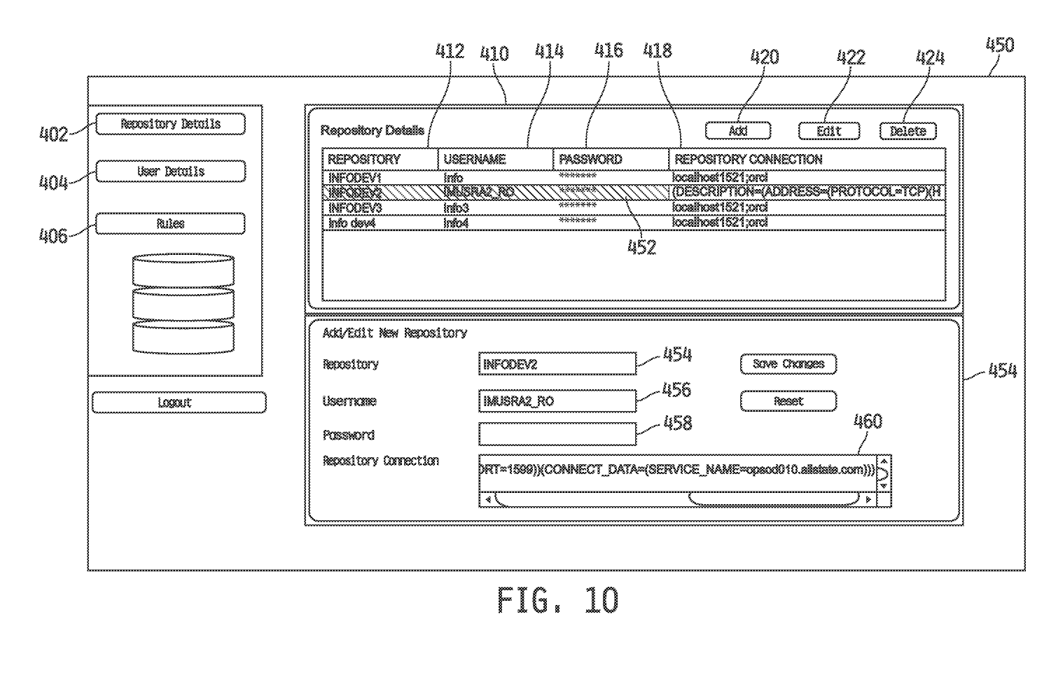

Referring again to FIG. 4, an administrator may log into the system 10 for the purpose of configuring one or more repositories, one or more users and/or one or more object rules. Referring to FIGS. 9 and 10, example graphical interfaces 400 and 450 are shown for accessing and configuring integrated data repositories stored within the database 50. Each graphical interface 400 and 450 is displayed by the processor 22 on a display monitor included in the peripheral devices 36 of the computing device 20. The graphical interfaces 400 and 450 each include, for example, a graphic legend via which an administrator may select repository detail access 402, user detail access 404 or object rules access 406. In the example graphical interface 400 illustrated in FIG. 9, a menu 410 is shown of the repository catalog 76 having columns displaying the names 412 of the various repositories stored in the database 50, usernames 414 of users that have accessed and/or authored the corresponding repositories, passwords 416 associated with the corresponding usernames, and repository connections 418 identifying the locations and/or access paths of the various repositories. The graphic interface 400 further includes add, edit and delete graphics 420, 422 and 424 respectively, via which the administrator may correspondingly add, edit and delete repositories.

In the graphic interface 450 illustrated in FIG. 10, for example, the administrator has elected to edit the repository INFODEV2 as illustrated by the highlighted portion of the menu 410. Below the menu 410, an add/edit interface 452 is shown via which the administrator may edit the selected repository. The interface 452 includes, for example, a repository name input area 454, a username input area 456, a password input area 458 and a repository connection input area 460, each populated with the corresponding information from the selected repository INFODEV2. Within each of the input areas 454, 456, 458 and 460, the administrator may edit the displayed information as desired.

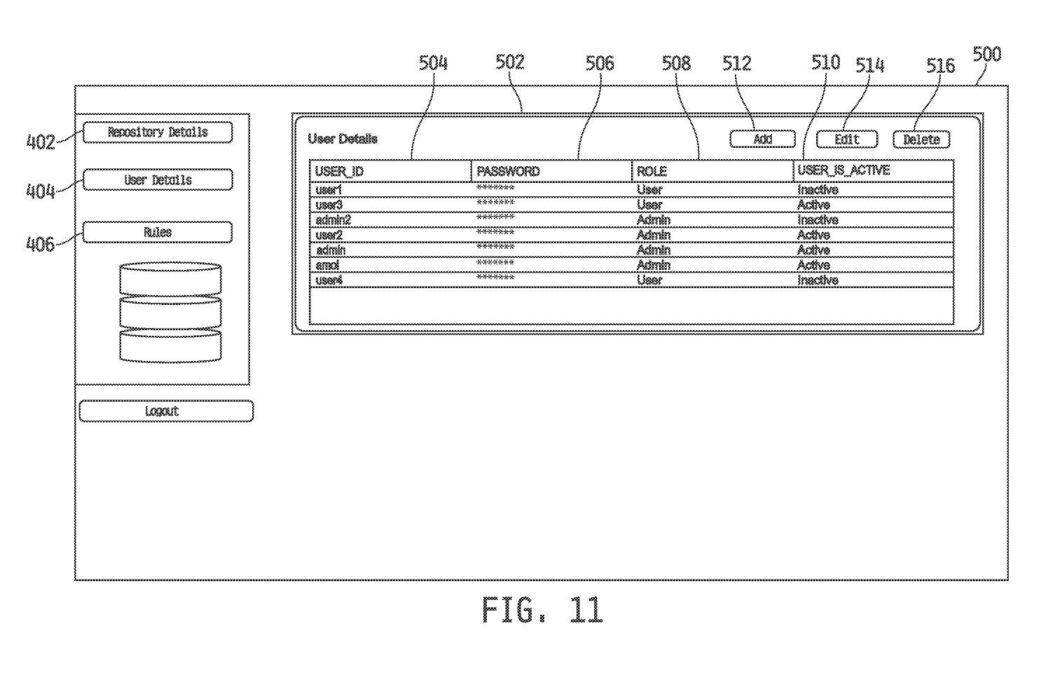

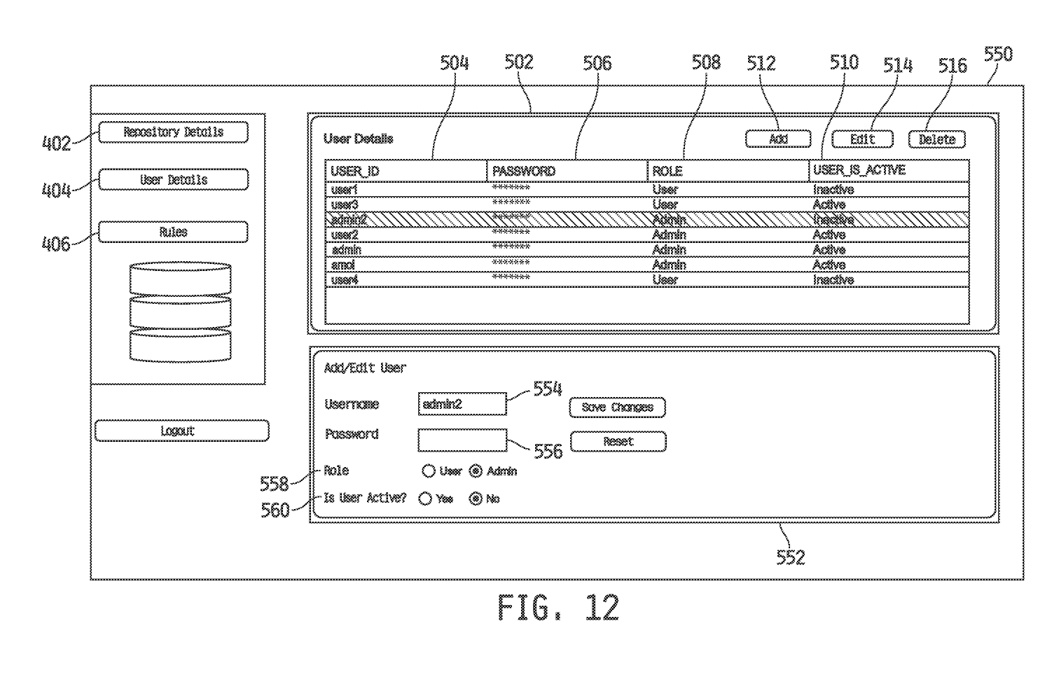

Referring now to FIGS. 11 and 12, example graphical interfaces 500 and 550 are shown for accessing and configuring user data stored within the users library 72 of the data storage 34. Each graphical interface 500 and 550 is displayed by the processor 22 on a display monitor included in the peripheral devices 36 of the computing device 20. The graphical interfaces 500 and 550 each include, for example, the same graphic legend described with respect to FIGS. 9 and 10 via which an administrator may select repository detail access 402, user detail access 404 or object rules access 406. In the example graphical interface 500 illustrated in FIG. 11, a menu 502 is shown of the users library 72 having columns displaying the names, i.e., user identifications or ID's, 504 of the various users of the system stored in the library 72, passwords 506 associated with the various user names, roles 508 associated with the various user ID's, e.g., user or administrator, and a user ID status 510, e.g., whether an active or an inactive user ID. The graphic interface 500 further includes add, edit and delete graphics 512, 514 and 516 respectively, via which the administrator may correspondingly add, edit and delete user information in the users library 72.

In the graphic interface 550 illustrated in FIG. 12, for example, the administrator has elected to edit the user ID admin2 as illustrated by the highlighted portion of the menu 502. Below the menu 502, an add/edit interface 552 is shown via which the administrator may edit the selected repository. The interface 552 includes, for example, a username input area 554, a password input area 556, a role selection graphic input area 558 and an active/inactive graphic input area 560, each populated with the corresponding information from the selected user ID admin2. Within each of the input areas 554, 556, 558 and 560, the administrator may edit the displayed information as desired.

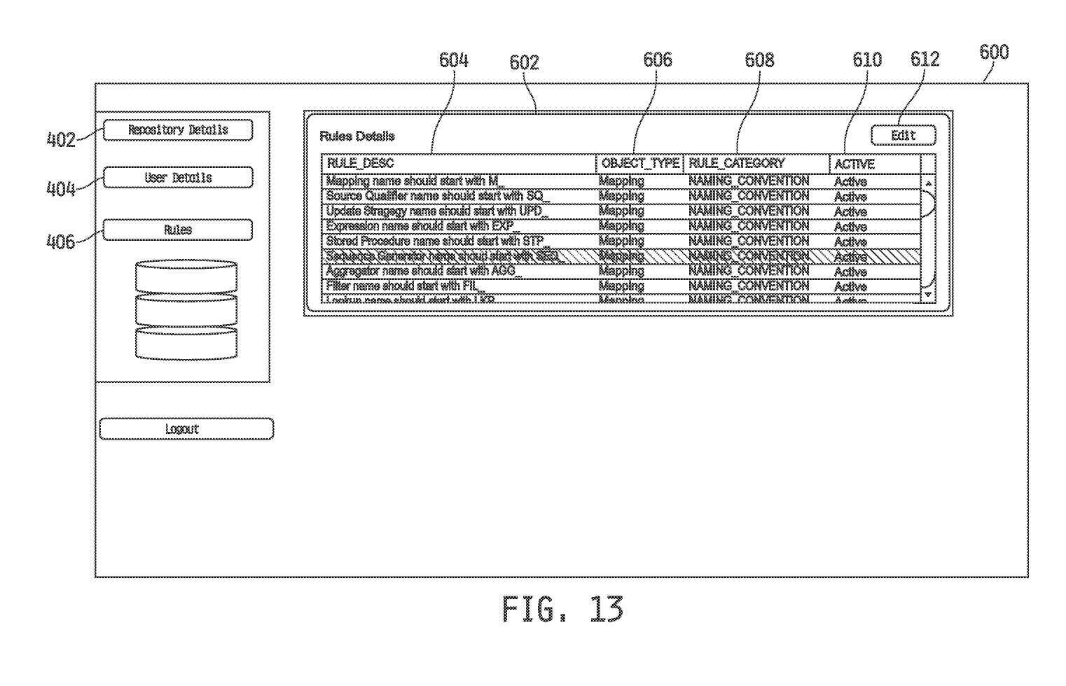

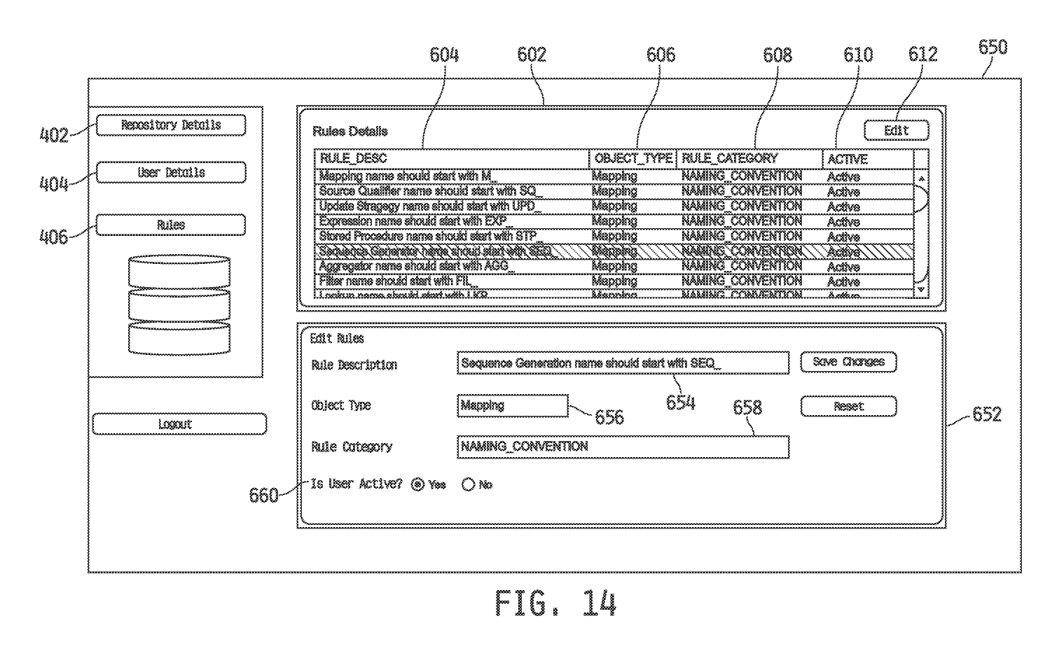

Referring now to FIGS. 13 and 14, example graphical interfaces 600 and 650 are shown for accessing and configuring object rules stored within the object rules library 70 of the data storage 34. Each graphical interface 600 and 650 is displayed by the processor 22 on a display monitor included in the peripheral devices 36 of the computing device 20. The graphical interfaces 600 and 650 each include, for example, the same graphic legend described with respect to FIGS. 9 and 10 via which an administrator may select repository detail access 402, user detail access 404 or object rules access 406. In the example graphical interface 600 illustrated in FIG. 13, a menu 602 is shown of the object rules library 70 having columns displaying textual descriptions 604 of the various rules stored in the library 70, Object Type 606 to which each object rule is applicable, e.g., mapping, session or workflow, Rule Category 608 under which each object rule is categorized, e.g., naming convention, documentation or performance, and Object Rule Status 610, e.g., whether an associated rule is currently active or inactive. The graphic interface 600 further includes an edit graphic 612 via which the administrator may edit the various components of the object rules stored in the object rules library 70. Illustratively, the graphic interface 600 may further include add and/or delete graphics via which an administrator may add/delete rules to/from the object rules library 70.

In the graphic interface 650 illustrated in FIG. 14, for example, the administrator has elected to edit the object rule “Sequence Generator name should start with SEQ” as illustrated by the highlighted portion of the menu 602. Below the menu 602, an edit interface 652 is shown via which the administrator may edit the selected object rule. The interface 652 includes, for example, a rule description input area 654, a an object type input area 656, a rule category input area 658 and an active/inactive graphic input area 660, each populated with the corresponding information from the selected object rule “Sequence Generator name should start with SEQ.” Within each of the input areas 654, 656, 658 and 660, the administrator may edit the displayed information as desired.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

What is claimed is:

1. A system for validating integrated data recasting objects, the system comprising:
a data storage including a rules library containing a plurality of object rules and one or more repositories each containing integrated data and one or more recasting objects, each of the one or more recasting objects containing a plurality of objects,
one or more computers communicatively coupled to the data storage,
an integrated data validation module on at least one of the one or more computers to conduct a validity test of at least one of the plurality of objects of a selected one of the one or more recasting objects of a selected one of the one or more repositories for compliance with one or more of the plurality of object rules, and
a report module on at least one of the one or more computers to produce a graphical representation of at least one result of the validity test.

2. The system of claim 1 wherein the integrated data validation module to conduct the validity test of each of a selected subset of the plurality of objects.

3. The system of claim 2 wherein the plurality of object rules includes a first subset of object rules and a second subset of rules that has at least one of the plurality of object rules that is not included in the first subset of rules,
and wherein the integrated data validation module to conduct the validity test of a first one of the selected subset of the plurality of objects for compliance with the first subset of object rules and of a second one of the selected subset of the plurality of objects for compliance with the second subset of rules.

4. The system of claim 1 wherein the integrated data validation module is responsive to user selection of one of the one or more repositories, to user selection of one of the one or more recasting objects of the selected repository, and to user selection of one or more of the plurality of objects of the selected recasting object to conduct the validation test.

5. The system of claim 1 further comprising a display monitor communicatively coupled to at least one of the one or more computers,
wherein the report module to control the display monitor to produce the graphical representation of the at least one result of the validity test in the form of a graphical representation of a pass or fail of compliance of the at least one of the plurality of objects with the one or more of the plurality of object rules.

6. The system of claim 5 wherein the report module to control the display monitor to produce the graphical representation of the pass or fail in the form of at least one of a table, a pie chart and a bar chart.

7. The system of claim 6 wherein the report module to control the display monitor to produce the graphical representation of the pass or fail in the form of a bar chart identifying pass or fail with respect to one or more of object naming convention, object documentation and object performance object rule categories.

8. The system of claim 1 wherein at least one of the one or more repositories contains integrated data recast from heterogeneous data using an extract, transform and load process,
and wherein the one or more recasting objects of the at least one of the one or more repositories include at least a mapping object, a session object and a workflow object.

9. A system for validating integrated data recasting objects, the system comprising:
a data storage including a rules library containing a plurality of object rules and one or more repositories each containing integrated data and one or more recasting objects, each of the one or more recasting objects containing a plurality of objects,
at least one processor communicatively coupled to the data storage, and
a memory having instructions stored therein which, when executed by the at least one processor, cause the at least one processor to
access a user selected one of the one or more repositories,
access a user selected one of the recasting objects of the user selected one of the one or more repositories,
access a user selected one or subset of the plurality of objects of the user selected one of the one or more recasting objects,
conduct a validity test of the user selected one or each of the subset of the plurality of objects for compliance with one or more of the plurality of object rules.

10. The system of claim 9 wherein the plurality of object rules includes a first subset of object rules and a second subset of rules that has at least one of the plurality of object rules that is not included in the first subset of rules,
and wherein the instructions stored in the memory further include instructions which, when executed by the at least one processor, cause the at least one processor to conduct the validity test of a first one of the selected subset of the plurality of objects for compliance with the first subset of object rules and of a second one of the selected subset of the plurality of objects for compliance with the second subset of rules.

11. The system of claim 9 wherein the user selected one of the one or more repositories contains integrated data recast from heterogeneous data using an extract, transform and load process,
and wherein the one or more recasting objects of the user selected one of the one or more repositories include at least a mapping object, a session object and a workflow object.

12. The system of claim 9 further comprising a display monitor communicatively coupled to the at least one processor,
wherein the instructions stored in the memory further include instructions which, when executed by the at least one processor, cause the at least one processor to control the display monitor to display a graphical representation of at least one result of the validity test.

13. The system of claim 12 wherein the instructions stored in the memory further include instructions which, when executed by the at least one processor, cause the at least one processor to control the display monitor to display the graphical representation of the at least one result of the validity test in the form of a graphical representation of a pass or fail of compliance of the at least one of the plurality of objects with the one or more of the plurality of object rules.

14. The system of claim 13 wherein the instructions stored in the memory further include instructions which, when executed by the at least one processor, cause the at least one processor to control the display monitor to display the graphical representation of the pass or fail in the form of at least one of a table, a pie chart and a bar chart.

15. The system of claim 14 wherein the instructions stored in the memory further include instructions which, when executed by the at least one processor, cause the at least one processor to control the display monitor to display the graphical representation of the pass or fail in the form of a bar chart identifying pass or fail with respect to one or more of object naming convention, object documentation and object performance object rule categories.

16. A method for validating integrated data recasting objects, the method comprising:
receiving on a computing device a first user input identifying a selected one of one or more repositories of integrated data stored in a data storage, each of the one or more repositories including, in addition to the integrated data, one or more recasting objects, each of the one or more recasting objects containing a plurality of objects,
receiving on the computing device a second user input identifying a selected one of the one or more recasting objects of the selected one of the one or more repositories,
receiving on the computing device a third user input identifying a selected one or subset of the plurality of objects of the selected one of the one or more recasting objects, and
in response to a fourth user input received on the computing device, conducting a validity test of the selected one or each of the subset of the plurality of objects for compliance with one or more of a plurality of object rules stored in the data storage.

17. The method of claim 16 wherein the selected one of the one or more repositories contains integrated data recast from heterogeneous data using an extract, transform and load process, and the one or more recasting objects of the selected one of the one or more repositories include at least a mapping object, a session object and a workflow object,
and wherein receiving the second user input comprises receiving a selection of one of the mapping object, the session object and the workflow object.

18. The method of claim 16 further comprising displaying a graphical representation of at least one result of the validity test on a display monitor.

19. The method of claim 18 further comprising displaying the graphical representation of the at least one result of the validity test on the display monitor in the form of a graphical representation of a pass or fail of compliance of the at least one of the plurality of objects with the one or more of the plurality of object rules.

20. The method of claim 19 further comprising displaying the graphical representation of the pass or fail in the form of at least one of a table, a pie chart and a bar chart, the bar chart identifying the pass or fail with respect to one or more rule object rule categories.
